(19) United States
(12) Patent Application Publication
(10) Pub. No.: US 2010/0102602 A1
(43) Pub. Date: Apr. 29, 2010

(54) Safety Seat Without Side Fittings

(76) Inventor: Holger Hansen, Hamburg (DE)

Correspondence Address: ROBERT W. BECKER & ASSOCIATES, 707 HIGHWAY 333, SUITE B, TIJERAS, NM, 87059-7507, US

(21) Appl. No.: 12/523,523

(22) PCT Filed: Jan. 9, 2008
(86) PCT No.: PCT/EP2008/000112

§ 371 Date: Jul. 16, 2009

(30) Foreign Application Priority Data
Jan. 16, 2007 (DE) 10 2007 002 372.5

(51) Int. Cl. B60R 22/00; B64D 11/06; A62B 35/00; B60R 21/00; B60N 2/42; A47C 15/00

(52) U.S. Cl. 297/216.1

(57) ABSTRACT

A safety seat for vehicles, including a seat portion having a rear end supported against vertical support straps of a strap framework secured to a vehicle. Each of two supports laterally disposed on the seat portion as a first end secured to the set. From the first end, each support extends in an inclined path, below the seat portion, to the vertical support straps. Each support has a free end remote from the first end and suspended in a loop formed on the vertical support straps. To tensioning straps are disposed beneath the seat portion and extend along side edges thereof from a front securement and the seat portion to a connection with the vertical support straps. Each tensioning strap has a length less than the distance between the front securement and the rear end of the seat portion.

The present invention relates to a safety seat for land vehicles, aircraft and watercraft, having a seat portion which is secured to a strap framework that is secured to the vehicle and has at least two vertical support straps.

A safety seat having the aforementioned features is known from DE 10 2004 062 350 B3. Here, the seat being in a form of a unit resistant to pressure is respectively secured to vertical support straps suspended between the roof of the vehicle and the base of the vehicle by securing the seat to the vertical support straps by means of additionally provided lateral carrying straps that are connected with the vertical support straps and together with them form a strap framework for supporting the seat. In this connection, the lateral carrying straps consist of a strap section that extends from a lower, permanent securement location along the side edges of the seat to their front corners, whereby from the front corners of the seat, a further respective strap section extends at an angle relative to the vertical axis of the vehicle seat and is guided back to an upwardly disposed, permanent securement location on the associated vertical support strap. Thus, the seat being in a form of a unit resistant to pressure is inserted into the strap framework formed of vertical support straps and carrying straps in such a way that the seat automatically spreads out or stretches the strap framework. Pursuant to one embodiment, additionally engaging the rear end of the seat is an operating cable for holding the seat up by raising it from its rear end.

The known safety seat has the drawback that the lateral carrying straps laterally hem in an occupant seated on the seat, so that when standing up the occupant can only rise up toward the front and can also only sit upon the seat from a position where the occupant is standing in front of the seat. However, there are frequently applications where a number of seats are arranged next to one another in a row oriented in a direction of travel of the vehicle, whereby especially when getting up, the occupants slide to the side over the seats that are arranged next to one another and leave the vehicle from the last seat of the row.

It is therefore an object of the present invention to improve a safety seat having the aforementioned features in such a way that with, as previously, a support of the seat portion on a strap framework, no fittings are arranged to the side of the seat portion that obstruct movement of the occupant.

The realization of this object, including advantageous embodiments of the invention, results from the content of the patent claims, which follow this description.

The basic concept of the invention is that the seat portion, the rear end of which is supported against the vertical support straps of the strap framework, is provided with two supports that are disposed on the side of the seat portion and are connected with the seat portion, wherein the supports extend from their securement on the seat portion, which is spaced from the rear end of the seat portion, in an inclined path beneath the seat portion to the vertical support straps of the strap framework, and with their free ends are suspended in loops that are formed on the vertical support straps, and in that beneath the seat portion, two tensioning straps are provided that extend along the side edges of the seat portion from a front securement on the seat portion to a connection with the vertical support straps, wherein the length of the tensioning straps is less than the distance between their front securements to the seat portion and the rear end of the seat portion that is supported against the vertical support straps.

The invention has the advantage that the seat portion of the safety seat is entirely secured or held on the vertical support straps of an appropriately provided strap framework that extend below the sitting surface, so that one can dispense with fittings, in particular lateral fittings, for holding the seat that are disposed above the sitting surface. Thus, the occupants can move freely over a row of safety seats that are disposed next to one another.

Upon implementation of such a holding, the seat portion is held by the tensioning forces that during loading of the seat by an occupant are applied by the supports and the tensioning straps to the vertical support straps of the strap framework, which tensioning forces act counter to one another. Thus, upon loading of the seat portion there results a compressive force that is transferred to the vertical support straps via the supports that are connected to the seat portion, so that the support straps are pressed or tensioned outwardly away from the seat portion. At the same time, upon loading of the seat portion the tensioning straps, due to their length at their securement locations with the vertical support straps, exert upon the support straps a traction force, so that the rear end of the seat portion is supported under tension against the vertical support straps of the strap framework, and is tensioned between the vertical support straps, the tensioning straps and the supports.

Due to the load that acts upon the seat portion, and due to the traction and compressive forces that result in the respective vertically oriented support straps, the straps of the strap framework on the one hand act as a tensioning element for the seat portion, and on the other hand also as shock absorbers that significantly reduce a direct introduction of force from vibrations or impacts originating from the vehicle, for example resulting from mine explosions, so that they do not penetrate to the occupant sitting on the seat.

Pursuant to one embodiment of the invention, the strap framework can be comprised of a belt strap that is guided through four anchoring devices that are arranged in a rectangle and are secured to a side structure of the vehicle, whereby the belt strap is formed with the two vertical support straps and with two diagonally extending crossed straps as well as with a horizontal cross strap, and a tensioning device for the strap framework is inserted into the horizontal cross strap. This has the advantage that this strap framework is secured to a side structure of the vehicle and to this extent to begin with the roof and base regions are kept free of fittings. To the extent that a continuous wheel well is frequently laterally formed in appropriate vehicles, and on the upper surface of which baggage or other equipment can be placed, the strap framework can be mounted on the lower side wall of the wheel well. In this way, the equipment resting on the wheel well is accessible.

Pursuant to one embodiment, the two upper anchoring devices that are secured to the vehicle are secured to the side structure of the vehicle above the seat portion.

With regard to an expedient securement of the strap framework on the vehicle, the anchoring devices that are secured to the vehicle can be embodied as eyebolts into which can be latched carabiner hooks that receive the belt strap in a guided manner, whereby pursuant to one embodiment, the connections of the tensioning straps with the vertical support straps of the strap framework can be embodied as D-rings that can be opened, that surround the support straps and are secured to the tensioning straps.

Pursuant to one embodiment of the invention the seat portion is in the form of a profiled structure having a circumferential frame and a textile sitting surface supported thereby, whereby the tensioning straps extend along the lateral profiled parts of the frame of the seat portion.

The corresponding seat portions can be foldably configured on the strap frameworks that hold them, as is in principle also provided with the safety seat in the aforementioned DE 10 2004 062 350 B3. Pursuant to one embodiment of the invention, the securements provided between the supports and the seat portion can be embodied as hinged connections in such a way that the seat portion can be folded up by raising its rear end about the hinged connections. In this connection, pursuant to one embodiment of the invention, an elastic pulling means can be attached to the seat portion, and its free end can be secured in the roof region of the vehicle in such a way that by means of the tension exerted by the pulling means, the seat portion is held in the folded-up position and is to be brought into the sitting position counter to the pretensioning.

Pursuant to one embodiment of the invention a shoulder harness is provided for securing an occupant that is seated on the seat portion, and is embodied in such a way that no permanent, lateral fittings are present, and that the belt strap parts of the shoulder harness are respectively detachable from the corresponding securement locations with the vehicle or with the seat portion, so that the shoulder harness can be put on and removed at any given time. In detail, a shoulder harness is provided that secures an occupant that is seated on the seat portion, and that is comprised of strap portions that in the back region of the occupant extend vertically between a releasable securement on the roof portion of the vehicle and the rear end of the seat portion, whereby the two strap portions are deflected at the seat portion and, in a crossed manner beneath the sitting surface of the seat portion, are guided to a securement disposed in the vicinity of the front edge of the seat portion, and whereby the shoulder harness is furthermore provided with shoulder straps that are held on the vertical strap portions, are guided over the shoulders of the occupant to a releasable securement disposed in the vicinity of the front edge of the seat portion, and are interconnected by means of a releasable cross connection disposed in the chest area of the occupant. A shoulder harness having such a configuration has the advantage that due to the strap portions that are respectively guided beneath the sitting surface of the seat portion, a closed strap system results that completely embraces the occupant and can operate independently of the carrying capacity of the seat portion. This arrangement is particularly important with regard to a mine blast below the base of the vehicle in order to uncouple the occupant that is sitting on the seat from the forces that occur. To this extent, especially when the sitting surface is configured as a textile supported sitting surface, the shoulder harness takes over a support function for the occupant, so that in contrast to the state of the art, it is no longer a matter of the details of the configuration of the sitting surface.

Pursuant to embodiments of the invention, the support of the shoulder straps on the vertical strap portions of the shoulder harness, and/or the cross connection on the shoulder straps that connect the shoulder straps, can be displaceably configured, so that an adaptation of the shoulder harness to the respective size conditions of the vehicle occupants results.

Pursuant to one embodiment of the invention, in a known manner the releasable cross connection can be embodied as a belt buckle having a buckle tongue that is insertable into a lock body where it can be detachably latched.

To the extent that the vertical strap portions of the shoulder harness could block access to the articles of equipment located in the vicinity of the back of the occupant, it is provided pursuant to an embodiment of the invention that the securement of the vertical strap portions with the roof portion be embodied as a rapid disconnect coupling.

For putting the shoulder straps of the shoulder harness on or taking them off, it is provided pursuant to an embodiment of the invention that the securement of the shoulder straps to the seat portion in the vicinity of the front edge thereof be embodied as a rapid disconnect coupling. In this connection, in an alternative embodiment of the invention, the rapid disconnect coupling can at the same time be configured for the securement of the end of the strap portion that respectively extends under the seat portion.

Pursuant to one embodiment of the invention, in the rear region of the seat portion, a back support can be provided that is suspended between the roof region and the seat portion. So that the back support does not block access to the articles of equipment disposed behind the occupant, pursuant to one embodiment the back support can be held in the roof region of the vehicle via detachable securements. To facilitate removal of the back support in certain applications, elastic pulling means can be secured to the detachable end of the back support for bringing the back support into a storage area.

Alternatively, the back support can be automatically pullable into a storage box secured to the vehicle, and the free end of the back support can be detachably connectable to the vehicle roof or the seat portion.

Pursuant to one embodiment of the invention, the back support can be provided with a head support region.

With regard to the configuration of the seat arrangement having a plurality of safety seats, pursuant to one embodiment of the invention the frame of the seat portion can have at least one bore, provided in its lateral profiled parts, for receiving a screw connection for connecting a plurality of safety seats to form a row of seats.

Embodiments of the invention are reproduced in the drawings, which will be described subsequently and in which:

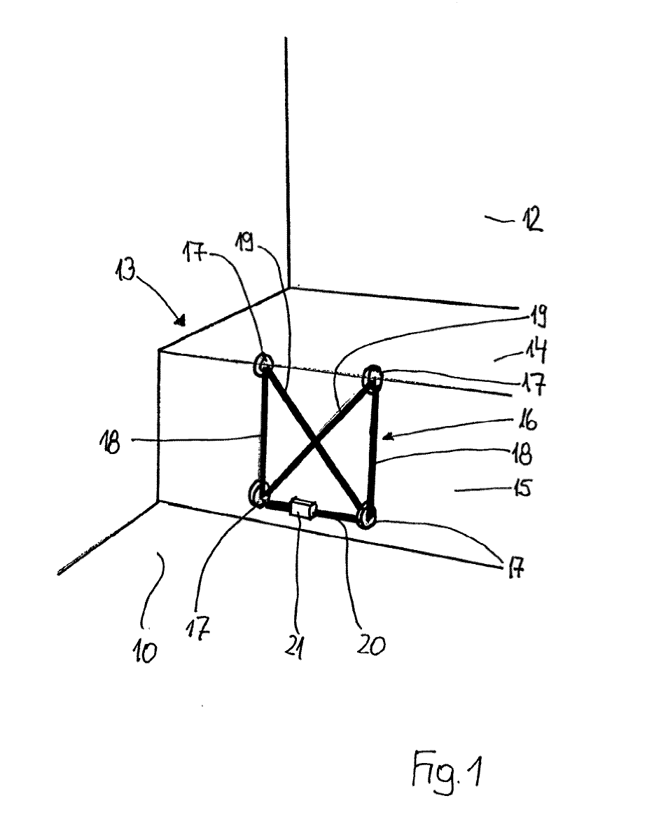

FIG. 1 shows an interior view of a vehicle having a strap framework disposed on the side structure of the vehicle,

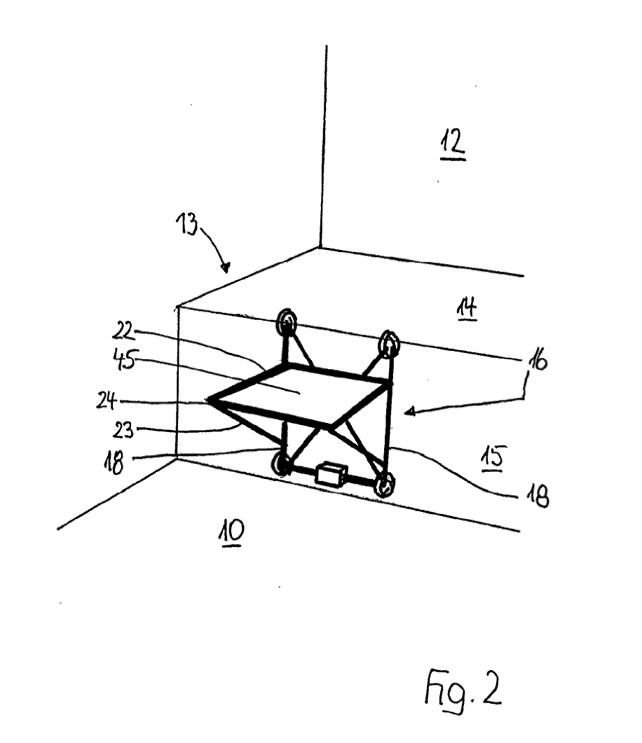

FIG. 2 shows the subject matter of FIG. 1 with a seat portion held on the strap framework,

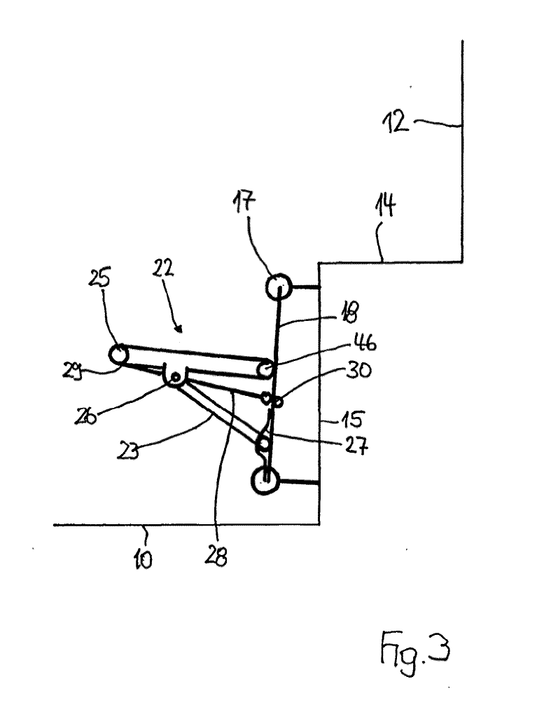

FIG. 3 is a side view of the subject matter of FIG. 2,

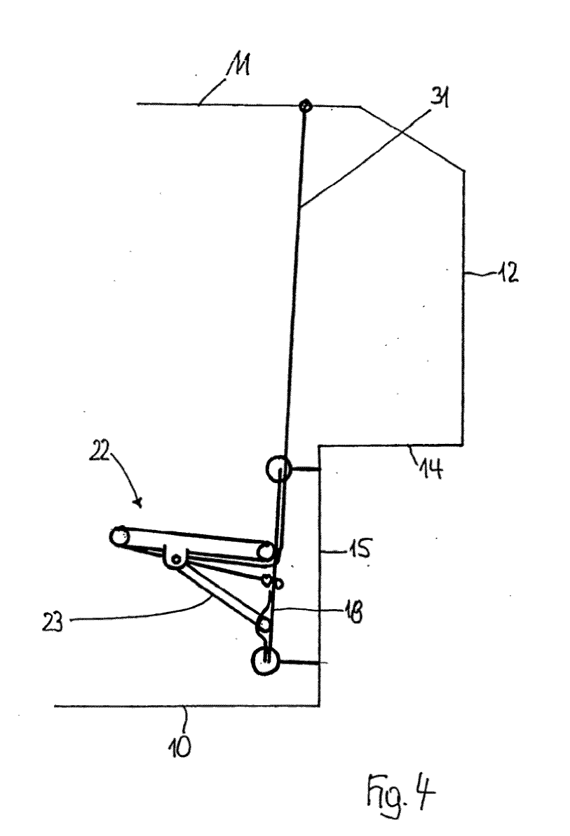

FIG. 4 shows the subject matter of FIG. 3 with an elastic pulling means configured for holding the seat portion when the seat portion is in the sitting position,

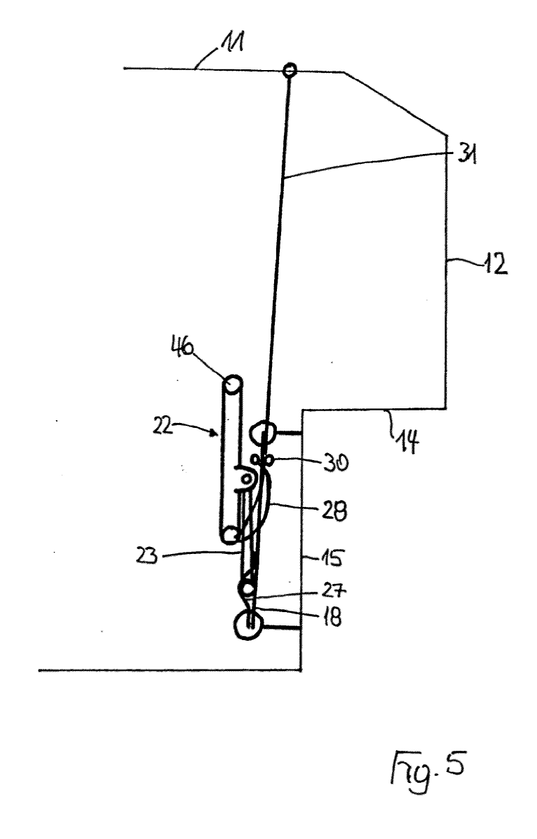

FIG. 5 shows the subject matter of FIG. 4 with the seat portion folded up,

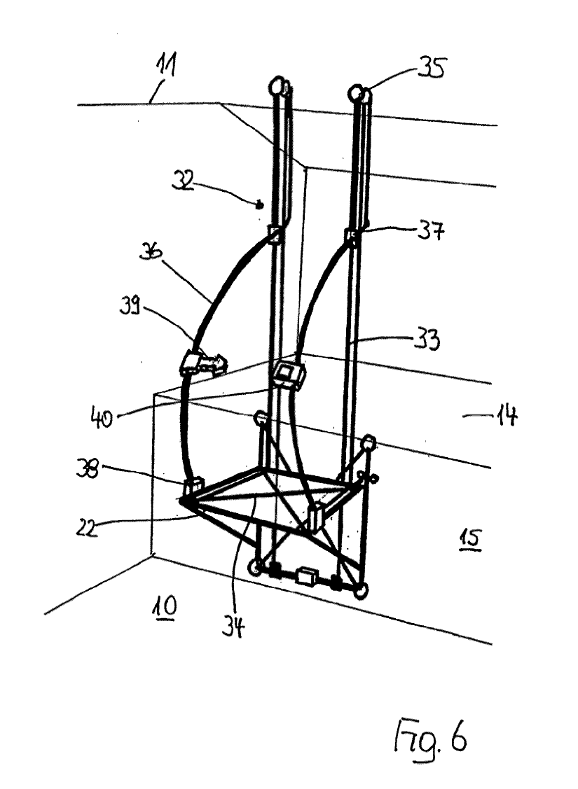

FIG. 6 shows the subject matter of FIG. 4 with an additionally provided shoulder harness,

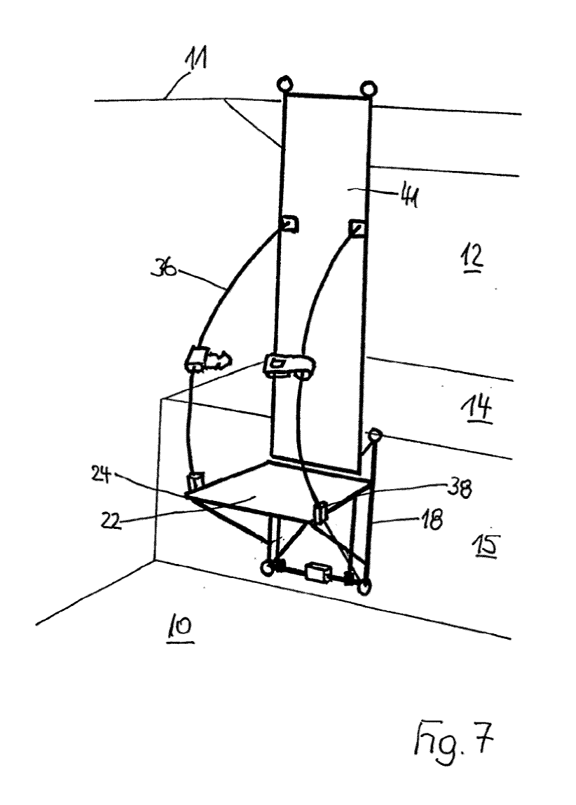

FIG. 7 shows the subject matter of FIG. 6 with an additional back support,

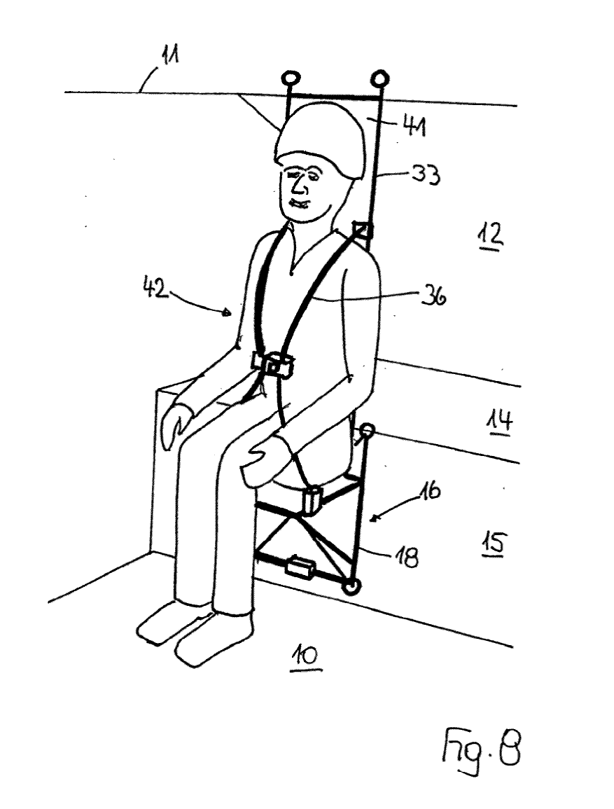

FIG. 8 shows the safety seat of FIGS. 1 to 7 with a person sitting thereon,

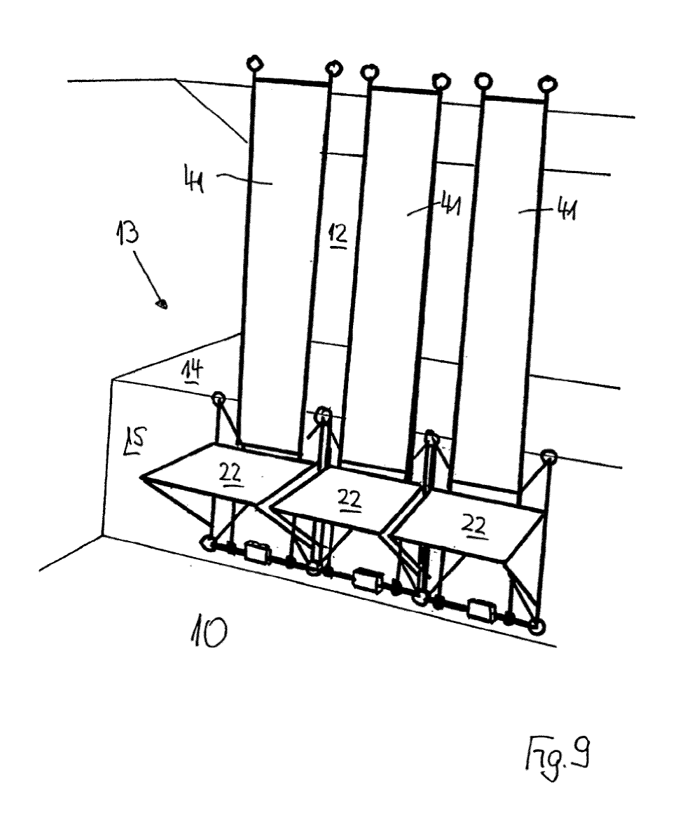

FIG. 9 shows a series of three safety seats arranged next to one another.

As can be seen in FIG. 1, an only schematically illustrated vehicle has a vehicle base 10 as well as a side wall 12, on which is formed a wheel well 13 having an upper surface 14 and a side structure 15. On the side structure 15, a strap framework 16 is supported on four anchoring devices 17 that are arranged in a rectangle, whereby the strap framework 16 is provided with two vertical support straps 18 that extend parallel to one another, two strap sections 19 that extend in a crossed manner, and a horizontal cross strap 20 in which is disposed a tensioning device 21. Although not illustrated in detail, the anchoring devices 17, which are secured to the vehicle, can be embodied as eyebolts in which are snapped or latched caribiner hooks that respectively receive a belt strap of the strap framework 16. To mount the strap framework 16 it is merely necessary to guide the belt strap through the anchoring devices 17 that are secured to the vehicle in such a way that the configuration of the strap framework 16 shown in FIG. 1 results, whereafter the strap framework 16 is appropriately pretensioned by means of the tensioning device 21.

As can be seen from FIG. 2, supported on the strap framework 16 is a seat portion 22 that is illustrated in the sitting position and that is in the form of a profiled structure having a circumferential frame 24 and a textile sitting surface 45 supported thereby. As can be schematically seen from FIG. 2, the seat portion 21pe is supported against the vertical support straps 18 of the strap framework 16 via lateral supports 23.

This arrangement for holding the seat portion 22 on the strap framework 16 can be seen in detail from FIG. 3. According to this showing, the supports 23 are secured to the associated lateral profiled parts 25 of the frame 24 by means of a hinged connection 26, so that the frame 24 of the seat portion 22 is movable relative to the supports 23. The free ends of the supports 23 are secured in loops 27 formed on the vertical support straps 18 of the strap framework 16. Furthermore, tensioning straps 28 are provided that extend below the lateral profiled parts 25, and that extend from a front securement 29 on the frame 24 to the vertical support straps 18 of the strap framework 16 and are secured thereon via D-rings 30 that surround the support straps 18 and are to be opened. In this connection, the tensioning straps 28 have a [length that is shorter] than the distance between their front securements 29 on the frame 24, and the rear end 46 of the seat portion 22 that supports them against the vertical support straps 18 and is formed by a corresponding profiled part. The arrangement of the supports 23 and the tensioning straps 28, upon loading of the seat portion 22 by an occupant seated thereon, causes the supports 23 to exert compressive forces upon the vertical support straps 18, while at the same time the tensioning straps 28 exert appropriate traction or tensile forces upon the vertical support straps 28, so that due to these oppositely directed tensioning forces, a reliable support of the seat portion 22 on the vertical support straps 18 results, without the seat portion 22, for example as is the case in the state of the art, having to be held by straps that support the seat portion and are suspended on upper anchors.

As can be seen from FIG. 4, due to the inventive support of the seat portion 22 on the strap framework 16, an easy ability of the seat portion to be folded is provided by attaching one end of an elastic pulling means 31 to the roof 11 of the vehicle, and connecting its other end, in the region of the hinge connection 26, with the frame 24 of the seat portion 22, such that the seat portion is held in the folded-up position by the pre-loading or biasing force exerted by the pulling means. In order to bring the seat portion 22 into the sitting position of FIG. 4, it is merely necessary to press the rear end 46 of the seat portion 22 down against the vertical support straps 18 of the strap framework 16, so that the described bracing of the seat portion 22 via the supports 23 and the tensioning straps 28 with the vertical support straps 18 results.

The seat portion described in FIGS. 1 to 5 is in principle adequate for accommodating the occupant that is to be transported by the vehicle, whereby in a straightforward embodiment, in addition a simple lap belt can be provided that, for example, can also be secured to the strap framework 16 or the anchoring devices 17 that are secured to the vehicle. However, in order to be able to obtain permission for street travel for vehicles equipped with such safety seats, it is necessary to provide a shoulder harness for securing an occupant, which also should dispense with fixed, side fittings or components. Such a shoulder harness is illustrated in FIG. 6. The shoulder harness 32 is first of all comprised of vertically extending strap portions 33 that are respectively disposed in the vicinity of the back of an occupant; one end of the strap portions is secured to a detachable securement on the vehicle roof 11, preferably in the form of a rapid disconnect coupling 35, whereby the two vertically extending strap portions 33 are deflected or have a change in direction at the seat portion 22, i.e. the rear end 46 thereof, and are guided in a crossed manner beneath the sitting surface 45 of seat portion 22 to a securement disposed in the vicinity of the front edge of the seat portion 22. In addition, the shoulder harness 32 is provided with shoulder straps 36 that are held on the vertical strap portions 33 and are guided over the shoulders of an occupant that is not illustrated in FIG. 6 (see FIG. 8) to a securement that is disposed in the vicinity of the front edge of the seat portion 22 and is embodied as a rapid disconnect coupling 38. The shoulder straps 36 can be connected to one another by means of a detachable cross connection that is disposed in the vicinity of the chest of the occupant, whereby this cross connection is comprised of a buckle lock secured to one of the shoulder straps 36 and a tongue 39 secured to the other shoulder strap 36. Although not illustrated in detail, the lock 40 and tongue 39 could be configured to be displaceable along the shoulder straps 36 that carry them in order to enable an adaptation to size conditions. To the extent that the shoulder straps 36 are connected to the vertical portions 33 of the shoulder harness 32, sliders 37 are provided for this purpose, via which the position of the shoulder straps 36 can be adapted to the size of the strapped-in occupant.

As can be seen from FIG. 7, a back support 41 can additionally be provided, and is suspended between the roof 11 and the side structure 15 of the vehicle. In the illustrated embodiment, the upper end of the back support 41 is mounted on the roof of the vehicle via appropriate detachable securements, so that the back support 41 is detachable from the roof 11 of the vehicle and falls down to the seat portion 22, to free the upper surface 14 of the wheel well 13 on which possibly articles of equipment are placed. The removal of the back support 41 can be facilitated with elastic bands that extend along the back support to its upper securement and that upon release of the back support 41 from the roof 11 of the vehicle facilitate the lowering of the back support 41. Although not illustrated, the back support can also be stored in appropriate storage boxes from which it can be pulled and secured in position in the vehicle.

FIGS. 8 and 9 finally show a safety seat according to FIGS. 1 to 7 in use with an occupant 42 seated thereon; furthermore, FIG. 9 shows the arrangement of three safety seats disposed next to one another, from which it is recognizable that the occupants must respectively slide to the side over the row of safety seats when exiting the vehicle. Although not illustrated, the lateral profiled parts 25 of the associated frames 24 that are disposed parallel next to one another can be provided with bores for receiving appropriate screw connections for connecting the respectively adjacent frames 24.

The features of the subject matter of these documents disclosed in the preceding specification, the patent claims, the abstract and the drawings can be important individually as well as in any desired combination with one another for realizing the various embodiments of the invention.

1-21. (canceled)

22. A safety seat for land vehicles, aircraft and watercraft, comprising:
a seat portion;
a strap framework that is adapted to be secured to a vehicle and that has at least two vertical support straps (18), wherein a rear end of said seat portion is supported against said vertical support straps;
two supports that are laterally disposed on, and connected to, said seat portion, wherein each of said supports has a first end that is secured to said seat portion at a distance from said rear end of said seat portion, further wherein from said first end, each of said supports extends in an inclined path, below said seat portion, to said vertical support straps of said strap framework and wherein each of said supports has a free end that is remote from said first end thereof, said free end being suspended in a loop formed on said vertical support straps; and
two tensioning straps that are disposed beneath said seat portion and extend along side edges of said seat portion from a front securement on said seat portion to a connection with said vertical support straps, wherein each of said tensioning straps has a length that is less than a distance between said front securements on said seat portion and said rear end of said seat portion that is supported against said vertical support straps.

23. A safety seat according to claim 22, wherein said strap framework is comprised of a belt strap that is guided through four anchoring devices that are arranged in a rectangle and are secured to a side structure of the vehicle, further wherein said belt strap is configured with said vertical support straps, with two diagonally extending cross straps and with a horizontal cross strap, and wherein a tensioning device for said strap framework is disposed in said cross strap.

24. A safety seat according to claim 23, wherein two upper ones of said anchoring devices are secured to said side structure of the vehicle above said seat portion.

25. A safety seat according to claim 23, wherein said anchoring devices are embodied as eyebolts into which can be latched carabiner hooks that are adapted to receive the belt strap in a guided manner.

26. A safety seat according to claim 22, wherein said connections of said tensioning straps with said vertical support straps of said strap framework are embodied as D-rings that can be opened, that surround said vertical support straps and that are secured to said tensioning straps.

27. A safety seat according to claim 22, wherein said seat portion is in the form of a profiled structure having a circumferential frame and a sitting surface that is supported on said frame, and wherein said tensioning straps extend along lateral profiled parts of said frame.

28. A safety seat according to claim 22, wherein said securements of said first end of said supports to said seat portion are configured as hinged connections such that said seat portion is adapted to be folded up by a raising of said rear end of said seat portion about said hinged connections.

29. A safety seat according to claim 28, wherein an elastic pulling means is attached to said seat portion, further wherein a free end of said pulling means is secured in a roof portion of the vehicle such that by means of tension exerted by said pulling means, said seat portion is adapted to be held in a folded-up position and to be brought to a sitting position against the pretension of said pulling means.

30. A safety seat according to claim 22, which further comprises a shoulder harness for securing an occupant that is to be seated in said seat portion, wherein said shoulder harness is comprised of two strap portions adapted to be disposed in the vicinity of a back of an occupant, further wherein each of said strap portions is adapted to extend vertically between a releasable securement on a roof portion of the vehicle and the rear end of said seat portion, further wherein said two strap portions are deflected at said rear end of said seat portion and are then guided in a crossed manner beneath a sitting surface of said seat portion to a respective securement disposed in the vicinity of a front edge of said seat portion, further wherein said shoulder harness is comprised of two shoulder straps adapted to be guided over shoulders of an occupant, further wherein each of said shoulder straps is held on a respective one of said strap portions and extends to a releasable securement in the vicinity of said front edge of said seat portion, and wherein said shoulder straps include a releasable cross connection for interconnecting said shoulder straps in the vicinity of a chest of an occupant.

31. A safety seat according to claim 30, wherein said holding of said shoulder straps on said vertically extending strap portions of said shoulder harness is configured to be displaceable.

32. A safety seat according to claim 30, wherein said cross connection on said shoulder straps that connects said shoulder straps is guided in a displaceable manner.

33. A safety seat according to claim 30, wherein said releasable cross connection is embodied as a belt buckle that includes a buckle tongue that is adapted to be inserted and detachably latched in a buckle body.

34. A safety seat according to claim 30, wherein at least one of said securement of said vertically extending strap portions with said roof portion, and said securement of said shoulder straps on said seat portion in the vicinity of said front edge thereof, is embodied as a rapid disconnect coupling.

35. A safety seat according to claim 34, wherein said rapid disconnect coupling for said securement of said shoulder straps is simultaneously configured for securement of an end of said strap portion (33) that respectively extends beneath said seat portion.

36. A safety seat according to claim 22, wherein a back support is provided in the vicinity of said rear end of said seat portion, and wherein said back support is suspended between the roof portion of the vehicle and said seat portion.

37. A safety seat according to claim 36, wherein said back support is held on said roof portion (11) of the vehicle via detachable securements.

38. A safety seat according to claim 36, wherein elastic pulling means for bringing said back support into a storage area are secured to a releasable end of said back support.

39. A safety seat according to claim 36, wherein said back support is adapted to be automatically pulled into a storage box secured to the vehicle, and wherein a free end of said back support is adapted to be detachably secured to said roof portion or to said seat portion.

40. A safety seat according to claim 36, wherein said back support is provided with a head support region.

41. A safety seat according to claim 22, wherein said frame of said seat portion is provided with at least one bore disposed in lateral profiled parts of said frame for receiving a screw connection for connecting a plurality of said safety seats to form a row of said seats.
